(19) United States
(12) Patent Application Publication
(10) Pub. No.: US 2023/0118860 A1
(43) Pub. Date: Apr. 20, 2023

(54) INJECTION MOLDING APPARATUS

(71) Applicant: SEIKO EPSON CORPORATION, Tokyo (JP)

(72) Inventors: Hidenobu MARUYAMA, Azumino (JP); Kenta ANEGAWA, Matsumoto (JP)

(21) Appl. No.: 17/964,947

(22) Filed: Oct. 13, 2022

(30) Foreign Application Priority Data
Oct. 14, 2021 (JP) 2021-168633

(51) Int. Cl. B29C 45/46; B29C 45/20; B29C 45/76; B29C 45/74

(52) U.S. Cl. CPC B29C 45/46; B29C 45/20; B29C 45/76; B29C 45/74; B29C 2945/7604; B29C 2945/76204

(57) ABSTRACT

An injection molding apparatus includes a mixing section having a hollow cylinder and a stirring member disposed in the cylinder, the mixing section generating a mixed material by using the stirring member to mix a first liquid and a second liquid that flow through the cylinder, the first liquid containing a thermoset material and the second liquid containing a polymerization initiator for initiating a polymerization reaction of the thermoset material, an injection section having a nozzle and being configured to inject the mixed material from the nozzle toward a cavity defined by a fixed molding die and a movable molding die, and a detection section configured to detect a state in the cylinder.

The present application is based on, and claims priority from JP Application Serial Number 2021-168633, filed Oct. 14, 2021, the disclosure of which is hereby incorporated by reference herein in its entirety.

### BACKGROUND

### 1. Technical Field

The present disclosure relates to an injection molding apparatus.

### 2. Related Art

JP-A-2012-158127 discloses a process for injection molding of two liquid types of silicone rubber. In this method, silicone rubber is molded by mixing a first liquid and a second liquid, which are materials of silicone rubber, within a spiral groove formed in a rotating scroll, pressure feeding the material to an injection cylinder section, injecting the material from the injection cylinder section into a cavity of a molding die, and hardening the material injected into the cavity by heating.

In injection molding using molding material of two liquid types such as in JP-A-2012-158127, the quality of the molded article may deteriorate due to variations in the mixing ratio or mixed state of the two liquids. Although variations in the mixing ratio and the mixed state of two liquids can be grasped after the fact by inspecting the molded article, it is not possible to detect and cope with the deterioration in quality of the molded article beforehand using the method of grasping the mixing ratio and the mixed state of two liquids after the fact.

### SUMMARY

According to one aspect of the present disclosure, there is provided an injection molding apparatus. This injection molding apparatus includes a mixing section having a hollow cylinder and a stirring member disposed in the cylinder, the mixing section generating a mixed material by using the stirring member to mix a first liquid and a second liquid that flow through the cylinder, the first liquid containing a thermoset material and the second liquid containing a polymerization initiator for initiating a polymerization reaction of the thermoset material, an injection section having a nozzle and being configured to inject the mixed material from the nozzle toward a cavity defined by a fixed molding die and a movable molding die, and a detection section configured to detect a state in the cylinder.

### BRIEF DESCRIPTION OF THE DRAWINGS

FIG. 1 is a front view showing schematic configuration of an injection molding apparatus according to a first embodiment.

FIG. 2 is a cross sectional view taken along line II-II in FIG. 1.

FIG. 3 is a perspective view illustrating configuration of a first coupling member according to the first embodiment.

FIG. 4 is an exploded perspective view showing configuration of a second coupling member according to the first embodiment.

FIG. 5 is a graph showing pressure measured by a first pressure sensor of a first detection section.

FIG. 6 is a graph showing pressure measured by a third pressure sensor of the first detection section.

FIG. 7 is a first graph showing pressures measured by pressure sensors of a second detection section.

FIG. 8 is a second graph showing pressures measured by the pressure sensors of the second detection section.

FIG. 9 is a flowchart showing contents of an injection process according to the first embodiment.

FIG. 10 is a front view showing schematic configuration of an injection molding apparatus according to a second embodiment.

FIG. 11 is a flowchart showing a contents of an injection process according to the second embodiment.

FIG. 12 is a cross sectional view showing configuration of a nozzle according to a third embodiment.

FIG. 13 is a cross sectional view showing configuration of a nozzle according to a fourth embodiment.

### DESCRIPTION OF EMBODIMENTS

### A. First Embodiment

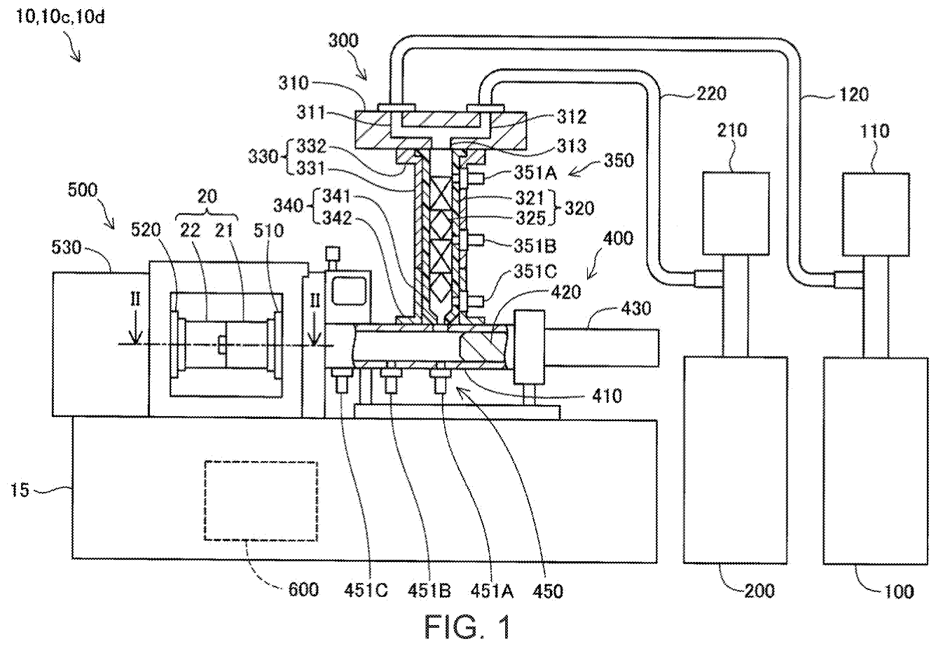

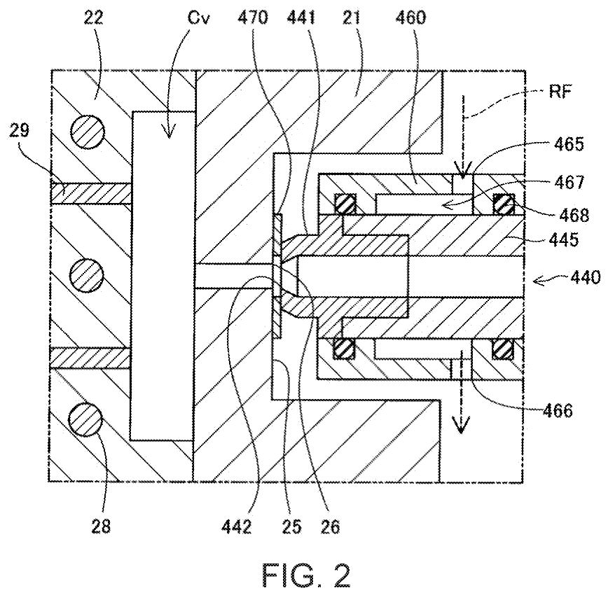

FIG. 1 is a front view showing schematic configuration of an injection molding apparatus 10 according to a first embodiment. FIG. 2 is a cross sectional view taken along line II-II in FIG. 1. A molding die 20 is attached to the injection molding apparatus 10 shown in FIG. 1. The injection molding apparatus 10 injects a two liquid type thermoset material into the molding die 20 to mold a molded article. The thermoset material includes at least one of a thermoset resin and a thermoset elastomer. In the present embodiment, the injection molding apparatus 10 injects a two liquid types of silicone rubber as the two liquid type thermoset material into the molding die 20.

The molding die 20 has a fixed molding die 21 and a movable molding die 22. The movable molding die 22 is disposed opposite to the fixed molding die 21. As shown in FIG. 2, the molding die 20 is provided with a cavity Cv defined by the fixed molding die 21 and the movable molding die 22 by contact between the fixed molding die 21 and the movable molding die 22. The cavity Cv is a space having a shape corresponding to the shape of the molded article. The molding die 20 is provided with a heater 28 for heating and hardening the two liquid type thermoset material injected into the cavity Cv. The molding die 20 is formed of a metal material, a resin material, or a ceramic material. The molding die 20 formed of a metal material may sometimes be referred to as a metal mold.

As shown in FIG. 1, the injection molding apparatus 10 includes a first tank 100, a first pump 110, a second tank 200, a second pump 210, a mixing section 300, a first detection section 350, an injection section 400, a second detection section 450, a molding die clamping section 500, and a control section 600. In the present embodiment, the mixing section 300, the injection section 400, and the molding die clamping section 500 are disposed on a base 15. The first tank 100, the first pump 110, the second tank 200, and the second pump 210 are disposed adjacent to the base 15. The control section 600 is disposed in the base 15. In FIG. 1, part of the mixing section 300 and the injection section 400 are shown in cross section for easy understanding of the technology.

A first liquid is stored in the first tank 100. The first liquid contains a main agent of the two liquid type thermoset material. In this embodiment, the first liquid contains a silicone polymer as the main agent of the two liquid type silicone rubber.

The first pump 110 is connected to the first tank 100. The first pump 110 pressure feeds the first liquid stored in the first tank 100 to the mixing section 300. In this embodiment, the first pump 110 is configured by a positive displacement pump. More specifically, the first pump 110 is configured by a screw pump. The first pump 110 is driven under the control of the control section 600. In the present embodiment, the first liquid sent out from the first pump 110 is supplied to the mixing section 300 via a first pipe 120 that connects the first pump 110 and the mixing section 300. It is desirable that the first pump 110 be able to send the first liquid to the mixing section 300 at a fixed amount and be able to suppress pulsating flow of the first liquid. In another embodiment, the first pump 110 may be configured by a positive displacement pump other than a screw pump, such as a gear pump, or may be configured by a turbo pump.

The second liquid is stored in the second tank 200. The second liquid contains a polymerization initiator that initiates the polymerization reaction of the two liquid type thermoset material. The polymerization reaction of the two liquid type thermoset material can be initiated by combining a predetermined amount of the first liquid and a predetermined amount of the second liquid.

The second pump 210 is connected to the second tank 200. The second pump 210 pressure feeds the second liquid stored in the second tank 200 to the mixing section 300. In this embodiment, the second pump 210 is configured by a positive displacement pump. More specifically, the second pump 210 is configured by a screw pump. The second pump 210 is driven under the control of the control section 600. In the present embodiment, the second liquid sent out from the second pump 210 is supplied to the mixing section 300 via a second pipe 220 that connects the second pump 210 and the mixing section 300. It is preferable that the second pump 210 be able to send the second liquid to the mixing section 300 at a fixed amount and be able to suppress a pulsating flow of the second liquid. In another embodiment, the second pump 210 may be configured by a positive displacement pump other than a screw pump, such as a gear pump, or may be configured by a turbo pump.

The mixing section 300 mixes and supplies the first liquid and the second liquid to the injection section 400. In this embodiment, the mixing section 300 includes a flow path member 310, a static mixer 320, a first coupling member 330, and a second coupling member 340.

In this embodiment, the flow path member 310 has a rectangular parallelepiped outer shape. The first pipe 120 and the second pipe 220 are connected to the flow path member 310. A first flow path 311, a second flow path 312, and a merging flow path 313 are provided inside the flow path member 310.

One end of the first flow path 311 communicates with the first pump 110 via the first pipe 120, and the other end of the first flow path 311 communicates with one end of the merging flow path 313. One end of the second flow path 312 communicates with the second pump 210 via the second pipe 220, and the other end of the second flow path 312 communicates with the one end of the merging flow path 313. The other end of the merging flow path 313 communicates with the static mixer 320. The first liquid flowing into the first flow path 311 from the first pipe 120 flows toward the merging flow path 313. The second liquid flowing into the second flow path 312 from the second pipe 220 flows toward the merging flow path 313. The first liquid and the second liquid merge in the merging flow path 313 and flow toward the static mixer 320.

The static mixer 320 includes a mixing cylinder 321 and a stirring member 325. The mixing cylinder 321 is a hollow member. In this embodiment, the mixing cylinder 321 is formed in a hollow cylindrical shape. One end of the mixing cylinder 321 is coupled to the flow path member 310 via the first coupling member 330. The other end of the mixing cylinder 321 is coupled to a side surface portion of an injection cylinder 410 (to be described later) via the second coupling member 340. The mixing cylinder 321 communicates with the merging flow path 313 and the injection cylinder 410. Specific configurations of the first coupling member 330 and the second coupling member 340 will be described later. The mixing cylinder 321 may sometimes be simply referred to as a cylinder.

The stirring member 325 is disposed in the mixing cylinder 321. In the present embodiment, the stirring member 325 is configured by a plurality of mixing elements connected to each other. The mixing elements are arranged side by side from one end to the other end of the mixing cylinder 321. Each mixing element has a shape obtained by twisting a rectangular plate 180 degrees. Rotation directions in the twists of adjacent mixing elements are different from each another. The mixing elements are fixed to an inner wall surface of the mixing cylinder 321 and are stationary with respect to the mixing cylinder 321. Although the stirring member 325 having four mixing elements is shown in FIG. 1 for easy understanding of the technology, the number of mixing elements of the stirring member 325 may be, for example, several or several tens.

The static mixer 320 mixes the first liquid and the second liquid flowing into the mixing cylinder 321 by a dividing action, a converting action, and an inverting action by each of the mixing elements of the stirring member 325. The dividing action is the action of dividing the flow of fluid. The converting action is an action of moving the fluid from a central axis of the mixing cylinder 321 toward an inner wall surface or from the inner wall surface toward the central axis. The inverting action is an action of inverting the direction of the vortex of the fluid flowing in a vortex state around the central axis of the mixing cylinder 321. In the following description, a mixture of the first liquid and the second liquid is referred to as a mixed material. In the present embodiment, the mixed material is in a gel state. In other embodiments, the mixed material may be in a liquid state.

In this embodiment, the mixing cylinder 321 and the stirring member 325 are made of a resin material such as polytetrafluoroethylene (PTFE) or polyvinyl chloride (PVC). In other embodiments, the mixing cylinder 321 and the stirring member 325 may be made of, for example, a metal material such as stainless steel or titanium alloy, or may be made of ceramic material. The mixing cylinder 321 and the stirring member 325 may be made of different materials.

The first detection section 350 is provided at the mixing cylinder 321. In the present embodiment, the first detection section 350 includes a first pressure sensor 351A, a second pressure sensor 351B, and a third pressure sensor 351C. The first pressure sensor 351A is provided in an upstream portion of the mixing cylinder 321, that is, in the vicinity of a connecting portion between the mixing cylinder 321 and the flow path member 310. The second pressure sensor 351B is provided in a midstream portion of the mixing cylinder 321. The third pressure sensor 351C is provided in a downstream portion of the mixing cylinder 321, that is, in the vicinity of a connecting portion between the mixing cylinder 321 and the injection cylinder 410.

Each of the pressure sensors 351A to 351C detects a respective pressure of the mixed material in the mixing cylinder 321. The information that relates to the pressures detected by the pressure sensors 351A to 351C is sent to the control section 600. In the following description, when the pressure sensors 351A to 351C are described without being particularly distinguished from each other, the pressure sensors 351A to 351C may sometimes be simply referred to as pressure sensors 351. The number of the pressure sensors 351 provided at the mixing cylinder 321 is not limited to three, but may be one or two or more. The first detection section 350 may sometimes be simply referred to as a detection section.

The injection section 400 measures the mixed material and injects the mixed material. In the present embodiment, the injection section 400 includes the injection cylinder 410, a plunger 420, a plunger drive section 430, and a nozzle 440 shown in FIG. 2.

The injection cylinder 410 is a hollow member. In this embodiment, the injection cylinder 410 is formed in a hollow cylindrical shape. The mixed material flowing in from the mixing cylinder 321 accumulates in the injection cylinder 410. The nozzle 440 is connected to an end portion of the injection cylinder 410. The plunger 420 is arranged in the injection cylinder 410. The plunger 420 is a columnar member. An outer peripheral side surface of the plunger 420 is provided along an inner wall surface of the injection cylinder 410. The plunger drive section 430 moves the plunger 420 along a central axis of the injection cylinder 410. The plunger drive section 430 injects the mixed material in the injection cylinder 410 from the nozzle 440 by moving the plunger 420 toward the nozzle 440. In this embodiment, the plunger drive section 430 is configured by combining a motor and a reduction gear. The plunger drive section 430 is driven under the control of the control section 600.

As shown in FIG. 2, in this embodiment, the nozzle 440 includes a nozzle tip 441, a nozzle flow path member 445, and a nozzle cover 460. The nozzle tip 441 is a hollow member. A nozzle port 442 for injecting the mixed material is provided at a tip end portion of the nozzle tip 441. A rear end portion of the nozzle tip 441 is fixed to the injection cylinder 410 via the nozzle flow path member 445. The nozzle port 442 communicates with the injection cylinder 410 via a flow path provided in the nozzle flow path member 445.

The tip end portion of the nozzle tip 441 contacts the fixed molding die 21. More specifically, an opening section 26 communicating with the cavity Cv is formed in the fixed molding die 21, and the tip end portion of the nozzle tip 441 contacts a surface 25 of the fixed molding die 21 in which the opening section 26 is formed. The mixed material injected from the nozzle port 442 is injected into the cavity Cv through the opening section 26. In the following description, the surface 25 of the fixed molding die 21, in which the opening section 26 is formed, is referred to as an opening section forming surface 25. In this embodiment, the opening section forming surface 25 is formed flat.

In the present embodiment, a sealing member 470 is disposed between the tip end portion of the nozzle tip 441 and the opening section forming surface 25, and the tip end portion of the nozzle tip 441 is in contact with the opening section forming surface 25 via the sealing member 470. The sealing member 470 is an annular shaped plate member and is made of a material softer than the material of the nozzle tip 441. The nozzle tip 441 is made of stainless steel, for example, and the sealing member 470 is made of, for example, aluminum. The thickness of the sealing member 470 is, for example, 0.01 mm to 0.1 mm. The sealing member 470 is sandwiched and compressed between the tip end portion of the nozzle tip 441 and the opening section forming surface 25. The sealing member 470 seals between the tip end portion of the nozzle tip 441 and the opening section forming surface 25. In order to suppress positional deviation of the sealing member 470, it is preferable that the sealing member 470 is fixed, by adhesive or the like, to the tip end portion of the nozzle tip 441 or the opening section forming surface 25. In other embodiments, the sealing member 470 may be formed of rubber or elastomer.

The nozzle cover 460 is provided so as to cover an outer peripheral side surface of the nozzle tip 441 and an outer peripheral side surface of the nozzle flow path member 445. In the present embodiment, a refrigerant inlet 465 and a refrigerant outlet 466 are provided at a side surface section of the nozzle cover 460. An inner wall surface of the nozzle cover 460 is provided with a groove shaped refrigerant flow path 467 for bringing the refrigerant inlet 465 and the refrigerant outlet 466 into communication with each other. A refrigerant RF is supplied to the refrigerant inlet 465. The refrigerant RF is, for example, water. The refrigerant RF introduced into the refrigerant flow path 467 from the refrigerant inlet 465 is discharged from the refrigerant outlet 466. The refrigerant RF discharged from the refrigerant outlet 466 is cooled by, for example, a chiller and circulated to the refrigerant inlet 465. An O ring 468 seals between the nozzle cover 460 and the nozzle tip 441 and between the nozzle cover 460 and the nozzle flow path member 445. The refrigerant flow path 467 may sometimes be referred to as a cooling section.

As shown in FIG. 1, the second detection section 450 is provided at the injection cylinder 410. In the present embodiment, the second detection section 450 includes a fourth pressure sensor 451A, a fifth pressure sensor 451B, and a sixth pressure sensor 451C. The fourth pressure sensor 451A is provided at an upstream portion of the injection cylinder 410. The fifth pressure sensor 451B is provided at a midstream portion of the injection cylinder 410. The sixth pressure sensor 451C is provided at a downstream portion of the injection cylinder 410, that is, in the vicinity of a connection section between the injection cylinder 410 and the nozzle 440.

The pressure sensors 451A to 451C detect pressures in the mixed material in the injection cylinder 410. The information that relates to the pressures detected by the pressure sensors 451A to 451C is sent to the control section 600. In the following description, when the pressure sensors 451A to 451C are described without being particularly distinguished from each other, the pressure sensors 451A to 451C may sometimes be simply referred to as the pressure sensors 451. The number of the pressure sensors 451 provided at the injection cylinder 410 is not limited to three, but may be one or two or more. The second detection section 450 may not be provided at the injection cylinder 410. The second detection section 450 may sometimes be simply referred to as a detection section.

The molding die 20 is attached to the molding die clamping section 500. The molding die clamping section 500 opens and closes the molding die 20. In this embodiment, the molding die clamping section 500 includes a fixed plate 510, a movable plate 520, and a molding die drive section 530. The fixed plate 510 is fixed to a tip end portion of a tie bar (not shown). The movable plate 520 is disposed opposite to the fixed plate 510 and moves while being guided by the tie bar. The fixed molding die 21 is mounted on the fixed plate 510, and the movable molding die 22 is mounted on the movable plate 520. The molding die drive section 530 moves the movable plate 520. In this embodiment, the molding die drive section 530 is configured by combining a motor, a reduction gear, and a ball screw. The molding die drive section 530 is driven under the control of the control section 600. The molding die 20 is opened and closed by the molding die drive section 530 moving the movable plate 520 and the movable molding die 22.

The control section 600 is configured by a computer including one or more processors, a memory, and an input/output interface that performs input and output of signals with the outside. The control section 600 controls each section of the injection molding apparatus 10 to mold the molded article by the processor executing a program or a command read into the memory. In the present embodiment, the control section 600 executes an injection process (to be described later) in molding the molded article. The control section 600 may be configured by a combination of a plurality of circuits instead of the computer.

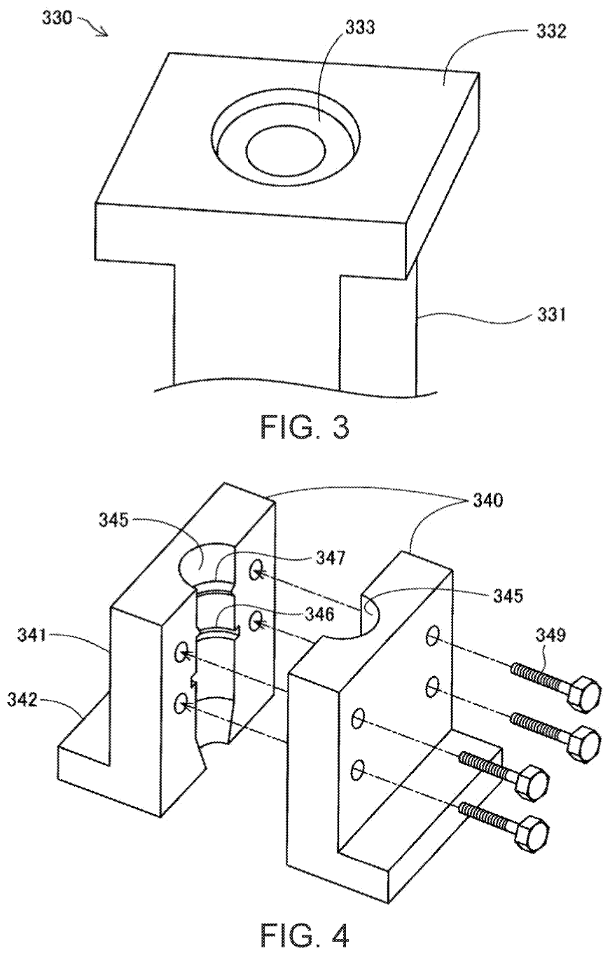

FIG. 3 is a perspective view showing configuration of the first coupling member 330 in the present embodiment. The first coupling member 330 includes a first hollow section 331 and a first flange section 332. The first hollow section 331 is configured to be hollow. The mixing cylinder 321 is inserted into the first hollow section 331. An inner wall surface of the first hollow section 331 is provided along the outer peripheral side surface of the mixing cylinder 321. The first flange section 332 is provided at an end portion of the first hollow section 331. A recessed bearing surface 333 is provided at the end portion of the first hollow section 331 to which the first flange section 332 is provided. When the flow path member 310 and the mixing cylinder 321 are coupled by the first coupling member 330, a tip end portion of the mixing cylinder 321 is inserted into the first hollow section 331 from the end portion in which the bearing surface 333 is provided. A rear end portion of the mixing cylinder 321 is formed in a flange shape, and the rear end portion of the mixing cylinder 321 comes into contact with the bearing surface 333. Four bolt holes 334 are provided in the first flange section 332, and, in a state where the rear end portion of the mixing cylinder 321 is in contact with the bearing surface 333, the first flange section 332 is fixed to the flow path member 310 by bolts inserted into the bolt holes 334. In the present embodiment, as shown in FIG. 3, the first hollow section 331 and the first flange section 332 are formed as an integral component, but in another embodiment, the first flange section 332 may be configured by a separate component from the first hollow section 331. Similarly to the second coupling member 340 (to be described later), each of the first hollow section 331 and the first flange section 332 may be configured by a plurality of components.

FIG. 4 is an exploded perspective view showing configuration of the second coupling member 340 in the present embodiment. The second coupling member 340 has a second hollow section 341 and a second flange section 342. The second hollow section 341 is configured to be hollow. The mixing cylinder 321 is inserted into the second hollow section 341. An inner wall surface 345 of the second hollow section 341 is provided along the outer peripheral side surface of the mixing cylinder 321. The second flange section 342 is provided at an end portion of second hollow section 341. In this embodiment, the second coupling member 340 is configured by two parts that are left-right symmetrically provided. The two components are provided with four bolt holes 344A each. The two components are fixed to each other by the bolts 349 inserted into the bolt holes 344A while the two components sandwich the tip end portion of the mixing cylinder 321. By fixing the two components to each other, the second hollow section 341 has a hollow configuration.

The inner wall surface 345 of the second hollow section 341 has a recess section 346 and a convex section 347. The recess section 346 is a portion of the inner wall surface 345 of the second hollow section 341 that is recessed outward in the radial direction of the second hollow section 341. The recess section 346 is provided in an annular shape around a central axis of the second hollow section 341. An O ring (not shown) is fitted into the recess section 346. A space between the inner wall surface 345 of the second hollow section 341 and the outside wall surface of the mixing cylinder 321 is sealed by the O ring.

The convex section 347 is a portion of the inner wall surface 345 of the second hollow section 341 that protrudes inward in the radial direction of the second hollow section 341. The convex section 347 is provided in an annular shape around the central axis of the second hollow section 341. The convex section 347 is in intimate contact with an outer wall surface of the mixing cylinder 321 to fix the mixing cylinder 321 by friction. The space between the inner wall surface 345 of the second hollow section 341 and the outside wall surface of the mixing cylinder 321 is sealed not only by an O ring but also by the convex section 347. Four bolt holes 344B are provided at the second flange section 342, and in a state where the mixing cylinder 321 is fixed to the second hollow section 341, the second flange section 342 is fixed to the injection cylinder 410 by bolts inserted into the bolt holes 344B.

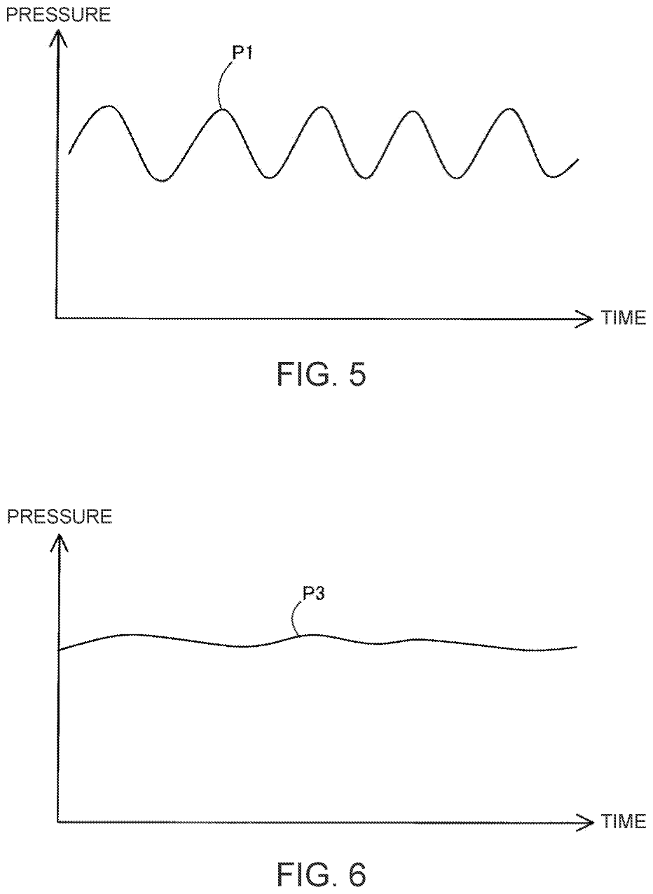

FIG. 5 is a graph showing the transition of pressure P1 measured by the first pressure sensor 351A. FIG. 6 is a graph showing the transition of pressure P3 measured by the third pressure sensor 351C. In FIGS. 5 and 6, the horizontal axis represents time and the vertical axis represents pressure.

In FIG. 5, the transition of pressure P1 in the upstream portion of the mixing cylinder 321 measured by the first pressure sensor 351A is represented. Since the first liquid and the second liquid are not sufficiently mixed in the upstream portion of the mixing cylinder 321, the ratio of the first liquid to the mixed material flowing over the first pressure sensor 351A fluctuates. Therefore, the waveform of the pressure P1 measured by the first pressure sensor 351A is a sine wave. In the present embodiment, since the viscosity of the mixed material increases as the proportion of the first liquid in the mixed material increases, the pressure of the mixed material increases as the proportion of the first liquid in the mixed material increases.

In FIG. 6, the transition of the pressure P3 in the downstream portion of the mixing cylinder 321 measured by the third pressure sensor 351C is represented. Since the first liquid and the second liquid are sufficiently mixed in the downstream portion of the mixing cylinder 321, the ratio of the first liquid to the mixed material flowing over the third pressure sensor 351C is substantially constant. Therefore, the amplitudes of the pressure P3 measured by the third pressure sensor 351C provided in the downstream portion of the mixing cylinder 321 are smaller than the amplitudes of the pressure P1 measured by the first pressure sensor 351A provided in the upstream portion of the mixing cylinder 321. In this embodiment, the pressure P3 measured by the third pressure sensor 351C provided in the downstream portion of the mixing cylinder 321 is substantially constant.

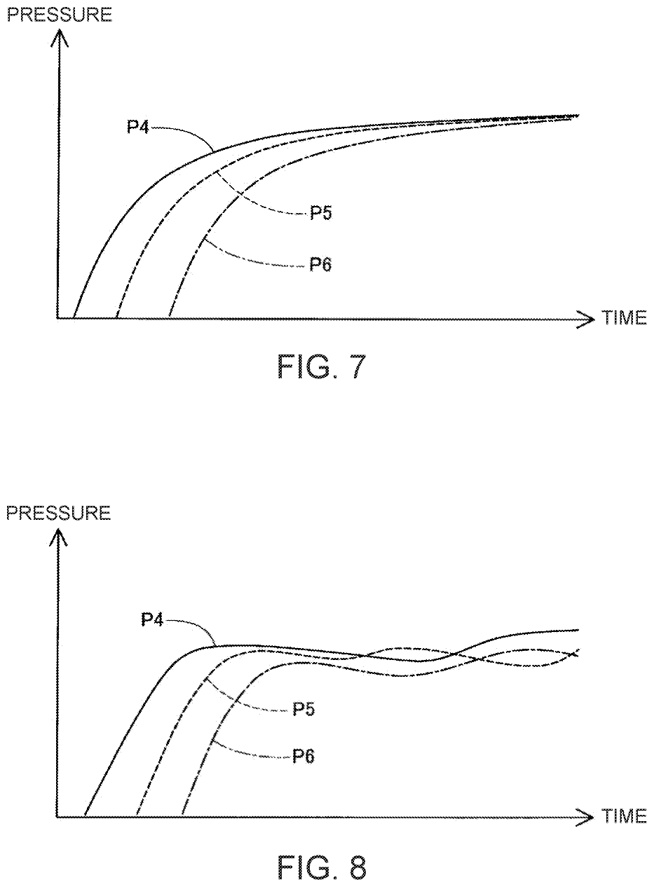

FIG. 7 is a first graph showing the transition of pressures P4 to P6 measured by the pressure sensors 451A to 451C, respectively, provided at the injection cylinder 410. FIG. 8 is a second graph showing the transition of pressures P4 to P6 measured by the pressure sensors 451A to 451C, respectively, provided at the injection cylinder 410. In FIGS. 7 and 8, the horizontal axis represents time and the vertical axis represents pressure. In FIGS. 7 and 8, the transition of pressure P4 measured by the fourth pressure sensor 451A is represented by solid line, pressure P5 measured by the fifth pressure sensor 451B is represented by broken line, and pressure P6 measured by the sixth pressure sensor 451C is represented by one dot chain line.

As shown in FIG. 7, when the first liquid and the second liquid are sufficiently mixed by the static mixer 320, the pressures P4 to P6 measured by the pressure sensors 451A to 451C, respectively, provided at the injection cylinder 410 increase with the passage of time and converge at a predetermined value. On the other hand, as shown in FIG. 8, for example, when the stirring member 325 of the static mixer 320 is broken and mixing of the first liquid and the second liquid by the static mixer 320 becomes insufficient, the pressures P4 to P6 measured by the pressure sensors 451A to 451C, respectively, increase with the passage of time, but fluctuate without converging even after the passage of a predetermined time.

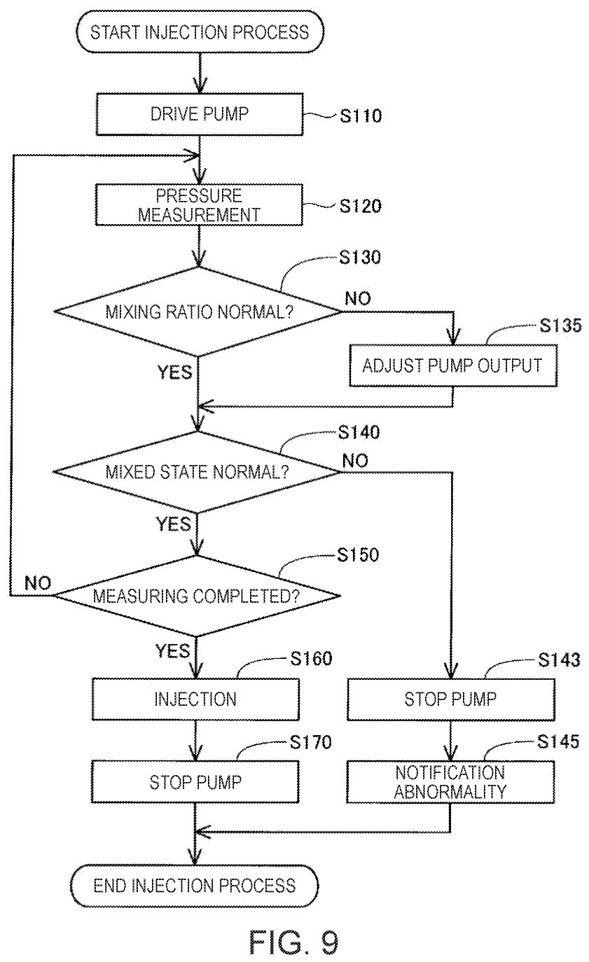

FIG. 9 is a flowchart illustrating content of the injection process in the present embodiment. When a predetermined start command is supplied to the control section 600, this process is started by the control section 600. The predetermined start command is supplied to the control section 600, for example, when a start button (not shown) provided in the injection molding apparatus 10 is pressed.

First, in step S110, the control section 600 starts supplying the first liquid from the first pump 110 to the static mixer 320 by driving the first pump 110, and starts supplying the second liquid from the second pump 210 to the static mixer 320 by driving the second pump 210.

Next, in step S120, the control section 600 measures the pressures of the mixed material in the mixing cylinder 321 using the pressure sensors 351A to 351C of the first detection section 350, and measures the pressures of the mixed material in the injection cylinder 410 using the pressure sensors 451A to 451C of the second detection section 450.

In step S130, the control section 600 determines whether or not the mixing ratio of the first liquid and the second liquid in the mixed material is normal. In the present embodiment, the control section 600 determines whether or not the mixing ratio of the first liquid and the second liquid in the mixed material is normal based on the pressures of the mixed material measured by the pressure sensors 351A to 351C of the first detection section 350. More specifically, when all the pressures measured by the pressure sensors 351A to 351C of the first detection section 350 are equal to or less than a predetermined upper limit value and also are equal to or more than a predetermined lower limit value, the control section 600 determines that the mixing ratio of the first liquid and the second liquid in the mixed material is normal. On the other hand, when at least one of the pressures measured by the pressure sensors 351A to 351C of the first detection section 350 is not equal to or lower than the predetermined upper limit value or is not equal to or higher than the predetermined lower limit value, the control section 600 determines that the mixing ratio of the first liquid and the second liquid in the mixed material is abnormal. The predetermined upper limit value and the predetermined lower limit value are set by a test performed in advance, for example.

When it is determined in step S130 that the mixing ratio of the first liquid and the second liquid in the mixed material is normal, the control section 600 advances the process to step S140. On the other hand, when it is not determined in step S130 that the mixing ratio of the first liquid and the second liquid in the mixed material is normal, in step S135 the control section 600 adjusts at least one of supply amount of the first liquid from the first pump 110 to the static mixer 320 and supply amount of the second liquid from the second pump 210 to the static mixer 320, and then proceeds the process to step S140.

In this embodiment, as described above, the greater the ratio of the first liquid to the mixed material, the higher the viscosity of the mixed material and the higher the pressures measured by the pressure sensors 351. Therefore, in the present embodiment, when at least one of the pressures detected by the pressure sensors 351A to 351C of the first detection section 350 exceeds the predetermined upper limit value, that is, when the ratio of the first liquid in the mixed material is higher than an expected ratio, the control section 600 reduces the output of the first pump 110 in step S135 to reduce the supply amount of the first liquid from the first pump 110 to the static mixer 320. Note that in another embodiment, the control section 600 may increase the supply amount of the second liquid from the second pump 210 to the static mixer 320 by increasing the output of the second pump 210, without decreasing the supply amount of the first liquid from the first pump 110 to the static mixer 320. The control section 600 may reduce the supply amount of the first liquid from the first pump 110 to the static mixer 320 and also increase the supply amount of the second liquid from the second pump 210 to the static mixer 320.

On the other hand, when at least one of the pressures measured by the pressure sensors 351A to 351C of the first detection section 350 is lower than the predetermined lower limit value, that is, when the ratio of the first liquid in the mixed material is lower than the expected ratio, in step S135 the control section 600 reduces the output of the second pump 210 to reduce the supply amount of the second liquid from the second pump 210 to the static mixer 320. Note that in another embodiment, the control section 600 may increase the supply amount of the first liquid from the first pump 110, to the static mixer 320 by increasing the output of the first pump 110 without decreasing the supply amount of the second liquid from the second pump 210 to the static mixer 320. The control section 600 may reduce the supply amount of the second liquid from the second pump 210 to the static mixer 320 and increase the supply amount of the first liquid from the first pump 110 to the static mixer 320.

In step S140, the control section 600 determines whether or not a mixed state of the first liquid and the second liquid is normal. When the mixed state of the first liquid and the second liquid is normal, that is, when the first liquid and the second liquid are sufficiently mixed, the amplitudes of the pressures measured by the pressure sensors 351A to 351C of the first detection section 350 decrease from upstream to downstream in the static mixer 320. However, for example, when the stirring member 325 of the static mixer 320 is broken, the first liquid and the second liquid will not be sufficiently mixed, and differences in the amplitude of the pressures measured by the pressure sensors 351A to 351C of the first detection section 350 will be smaller. Therefore, in the present embodiment, the control section 600 calculates the difference between the amplitude of the first pressure sensor 351A and the amplitude of the second pressure sensor 351B and the difference between the amplitude of the second pressure sensor 351B and the amplitude of the third pressure sensor 351C, and when the absolute value of the calculated difference is equal to or less than a predetermined value, the control section 600 determines that the mixed state of the first liquid and the second liquid is normal, and when the absolute value of the calculated difference exceeds the predetermined value, the control section 600 determines that the mixed state of the first liquid and the second liquid is abnormal.

In addition, as described above, when the mixed state of the first liquid and the second liquid is abnormal, the pressures measured by the pressure sensors 451A to 451C of the second detection section 450 fluctuate without converging to a predetermined value even after the passage of a predetermined time. Therefore, in the present embodiment, when the pressures measured by the pressure sensors 451A to 451C of the second detection section 450 fluctuate without converging to the predetermined value, even after the passage of the predetermined time, the control section 600 determines that the mixed state of the first liquid and the second liquid is abnormal.

If it is not determined in step S140 that the mixed state of the first liquid and the second liquid is normal, the control section 600 stops the first pump 110 and the second pump 210 in step S143,notifies in step S145 that the mixed state of the first liquid and the second liquid is abnormal, and then ends this process. The control section 600 notifies about the abnormality in the mixed state of the first liquid and the second liquid, for example, by displaying a message indicating the abnormality in the mixed state of the first liquid and the second liquid on a display section (not shown) provided in the injection molding apparatus 10.

When it is determined in step S140 that the mixed state of the first liquid and the second liquid is normal, the control section 600 determines in step S150 whether the measuring of the mixed material has been completed. In the present embodiment, the plunger 420 moves away from the nozzle 440 under the pressure from the mixed material as the storage amount of the mixed material in the injection cylinder 410 increases, and therefore whether or not measurement of the mixed material is completed is determined based on the position of the plunger 420. The position of the plunger 420 can be detected by, for example, a rotary encoder built in the motor constituting the plunger drive section 430.

When it is determined in step S150 that the measuring of the mixed material is completed, in step S160 the control section 600 drives the plunger drive section 430 to move the plunger 420 toward the nozzle 440 so as to inject the mixed material from the nozzle port 442. The mixed material injected from the nozzle port 442 is injected into the cavity Cv of the molding die 20 clamped in advance by the molding die clamping section 500. The control section 600 stops the first pump 110 and the second pump 210 in step S170, and then the control section 600 ends this process. The mixed material injected into the cavity Cv is hardened by heating from the heater 28 provided in the molding die 20. The term “hardening” as used herein includes the meaning that the mixed material becomes hard enough to have rubber elasticity. After the mixed material injected into the cavity Cv is hardened, the molding die 20 is opened by the molding die clamping section 500. With the opening operation of the molding die 20, an ejector pin 29 housed in a through hole provided in the movable molding die 22 protrudes from the movable molding die 22. The molded article made of the mixed material is released from the movable molding die 22 by the ejector pin 29 protruding from the movable molding die 22.

According to the injection molding apparatus 10 of the present embodiment described above, the control section 600 can detect a state in the mixing cylinder 321 into which flows the first liquid and the second liquid, by using the pressure sensors 351A to 351C of the first detection section 350 and the pressure sensors 451A to 451C of the second detection section 450. More specifically, the control section 600 can detect an abnormal state in the mixing ratio of the first liquid and the second liquid in the mixed material by using the pressure sensors 351A to 351C of the first detection section 350, and can detect an abnormal state in the mixed state of the first liquid and the second liquid in the mixed material using the pressure sensors 351A to 351C of the first detection section 350 and the pressure sensors 451A to 451C of the second detection section 450. Therefore, it becomes possible to detect and cope with degradation in quality of the molded article beforehand. In particular, in the present embodiment, when the mixing ratio of the first liquid and the second liquid in the mixed material is not normal, since the control section 600 adjusts at least one of the supply amount of the first liquid from the first pump 110 to the mixing cylinder 321 and the supply amount of the second liquid from the second pump 210 to the mixed cylinder 321 so that the mixing ratio of the first liquid and the second liquid in the mixed material becomes normal, it is possible to prevent the deterioration in quality of the molded article due to the abnormal of the mixing ratio of the first liquid and the second liquid in the mixed material beforehand.

In the present embodiment, the first detection section 350 includes three pressure sensors 351A to 351C provided at the mixing cylinder 321. Therefore, the state in the mixing cylinder 321 can be detected in detail as compared with a configuration in which the state in the mixing cylinder 321 is detected by one or two pressure sensors 351.

In the present embodiment, the mixing section 300 includes the static mixer 320. The static mixer 320 can effectively mix the first liquid and the second liquid without rotating the stirring member 325 disposed in the mixing cylinder 321 by a motor or the like. Therefore, energy consumption for mixing the first liquid and the second liquid can be reduced as compared with a configuration in which the first liquid and the second liquid are mixed by rotating the stirring member 325 by a motor or the like.

Further, in this embodiment, the mixing cylinder 321 is coupled to the flow path member 310 via the first coupling member 330, and the first coupling member 330 has the first hollow section 331 provided along the outer peripheral side surface of the mixing cylinder 321. Therefore, the mixing cylinder 321 can be reinforced by the first hollow section 331. In addition, for example, in a configuration in which a male screw is formed at the rear end portion of the mixing cylinder 321 and a female screw is formed in the flow path member 310, and the mixing cylinder 321 is connected to the flow path member 310 by the male screw and the female screw, the mixing cylinder 321 may separate from the flow path member 310 under the pressure of the mixed material. On the other hand, in the present embodiment, since the rear end portion of the mixing cylinder 321 configured in the flange shape is supported by the bearing surface 333 provided in the first coupling member 330, and the first flange section 332 is fixed to the flow path member 310 by four bolts, it is possible to prevent the mixing cylinder 321 from separating from the flow path member 310 under the pressure of the mixed material.

Further, in this embodiment, the mixing cylinder 321 is coupled to the injection cylinder 410 via the second coupling member 340, and the second coupling member 340 has the second hollow section 341 provided along the outer peripheral side surface of the mixing cylinder 321. Therefore, the mixing cylinder 321 can be reinforced by the second hollow section 341. Further, in the present embodiment, the space between the mixing cylinder 321 and the second hollow section 341 is sealed by the O ring or the convex section 347. Therefore, even if the mixed material leaks from the connecting portion between the mixing cylinder 321 and the injection cylinder 410, it is possible to suppress flow of the mixed material to outside.

In addition, in the present embodiment, since the refrigerant flow path 467 through which refrigerant flows is provided in the nozzle cover 460, it is possible to suppress an increase in temperature of the nozzle tip 441 and the nozzle flow path member 445. Therefore, hardening of the mixed material in the nozzle tip 441 and the nozzle flow path member 445 can be suppressed.

### B. Second Embodiment

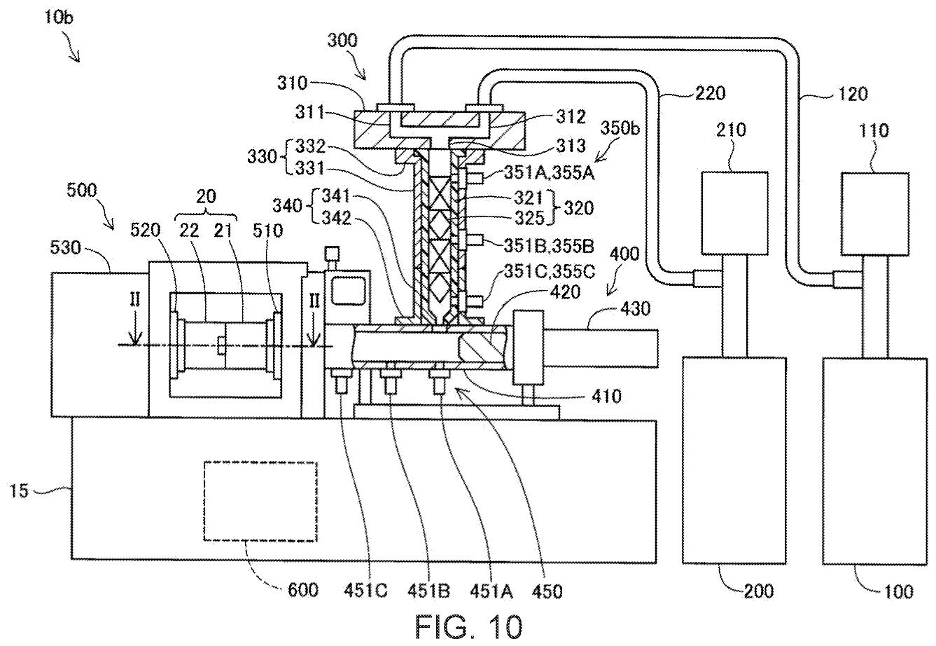

FIG. 10 is a front view showing a schematic configuration of an injection molding apparatus 10b according to a second embodiment. The injection molding apparatus 10b of the second embodiment differs from the first embodiment in that a first detection section 350b includes three temperature sensors 355A to 355C in addition to the three pressure sensors 351A to 351C. Other configurations are the same as those of the first embodiment unless otherwise described.

The temperature sensors 355A to 355C of the first detection section 350b are provided at the mixing cylinder 321. The temperature sensors 355A to 355C are disposed adjacent to the pressure sensors 351A to 351C, respectively. The temperature sensors 355A to 355C detect temperatures of the mixed material in the mixing cylinder 321. The information relating to the temperatures detected by the temperature sensors 355A to 355C is sent to the control section 600. In the following description, when the temperature sensors 355A to 355C are described without particularly distinguishing between them, the temperature sensors 355A to 355C may sometimes be simply referred to as temperature sensors 355. The number of temperature sensors 355 provided at the mixing cylinder 321 is not limited to three, and may be one or two or more.

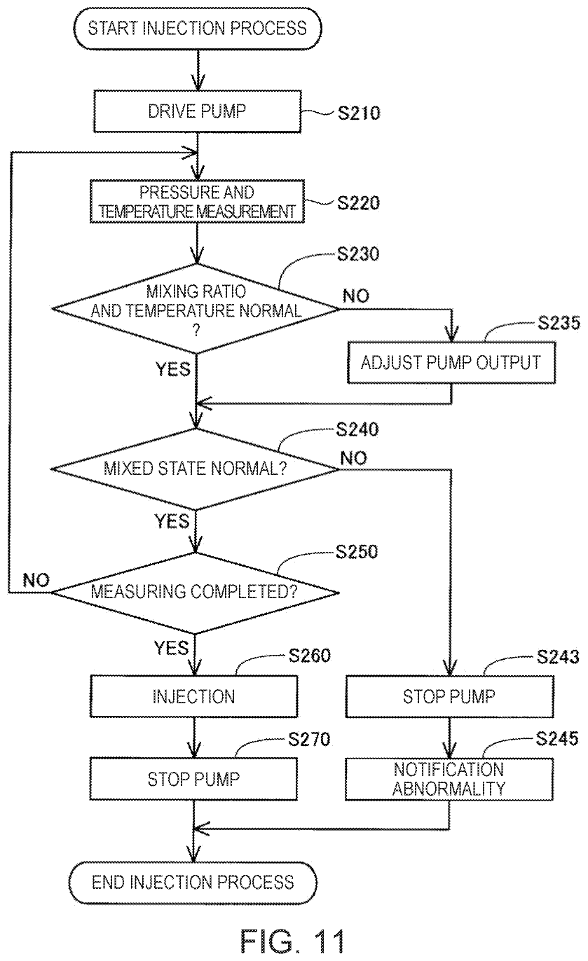

FIG. 11 is a flowchart illustrating content of the injection process in the present embodiment. First, in step S210, the control section 600 starts supplying the first liquid from the first pump 110 to the static mixer 320 by driving the first pump 110, and starts supplying the second liquid from the second pump 210 to the static mixer 320 by driving the second pump 210.

Next, in step S220, the control section 600 measures the pressures of the mixed material in the mixing cylinder 321 using the pressure sensors 351A to 351C of the first detection section 350b, and measures the pressures of the mixed material in the injection cylinder 410 using the pressure sensors 451A to 451C of the second detection section 450. Further, the control section 600 measures the temperatures of the mixed material in the mixing cylinder 321 by the temperature sensors 355A to 355C of the first detection section 350b.

In step S230, the control section 600 determines whether or not the mixing ratio of the first liquid and the second liquid in the mixed material and the temperature of the mixed material are normal. In the present embodiment, similarly to step S130 of the first embodiment, the control section 600 determines whether or not the mixing ratio of the first liquid and the second liquid in the mixed material is normal based on the pressures of the mixed material measured by the pressure sensors 351A to 351C of the first detection section 350b, and determines whether or not the temperature of the mixed material is normal based on the temperatures of the mixed material measured by the temperature sensors 355A to 355C of the first detection section 350b. When the temperature of the mixed material in the mixing cylinder 321 increases, hardening of the mixed material may be started, which may affect the quality of the molded article or may make it impossible to inject the mixed material from the nozzle port 442. Therefore, in the present embodiment, when the temperatures of the mixed material measured by the temperature sensors 355A to 355C are equal to or lower than a predetermined upper limit temperature, then the control section 600 determines that the temperature of the mixed material is normal, and when the temperatures of the mixed material measured by the temperature sensors 355A to 355C exceed the predetermined upper limit temperature, then the control section 600 determines that the temperature of the mixed material is abnormal. The upper limit temperature is set to be equal to or lower than the hardening temperature of the mixed material.

When it is determined in step S230 that the mixing ratio of the first liquid and the second liquid in the mixed material is normal and also that the temperature of the mixed material is normal, the control section 600 advances the process to step S240. On the other hand, when it is not determined in step S230 that at least one of the mixing ratio of the first liquid and the second liquid in the mixed material and the temperature of the mixed material is normal, then the control section 600 adjusts at least one of the supply amount of the first liquid from the first pump 110 to the static mixer 320 and the supply amount of the second liquid from the second pump 210 to the static mixer 320 in step S235, and then advances the process to step S240. The content of the process in step S235 when it is determined in step S230 that the mixing ratio of the first liquid and the second liquid in the mixed material is not normal is the same as the content of the process in step S135 of the first embodiment. The amount of heat generated by shear heating of the mixed material increases as the flow velocity of the mixed material in the mixing cylinder 321 increases. Therefore, if it is not determined in step S230 that the temperature of the mixed material is normal, then in step S235 the control section 600 reduces the flow velocity of the mixed material in the mixing cylinder 321 by reducing the supply amount of the first liquid from the first pump 110 to the static mixer 320 and reducing the supply amount of the second liquid from the second pump 210 to the static mixer 320. The content of processes in step S240 and thereafter are the same as the content in step S140 and thereafter in the first embodiment.

According to the injection molding apparatus 10b of the present embodiment described above, since the first detection section 350b also includes the three temperature sensors 355A to 355C in addition to the three pressure sensors 351A to 351C, the temperature of the mixed material in the mixing cylinder 321 can also be detected by the first detection section 350b. Further, in the present embodiment, when the temperatures of the mixed material detected by the temperature sensors 355A to 355C exceeds the predetermined upper limit temperature, the control section 600 reduces the amount of the first liquid supplied from the first pump 110 to the mixing cylinder 321 and the amount of the second liquid supplied from the second pump 210 to the mixing cylinder 321, so as to suppress an increase in the temperature of the mixed material in the mixing cylinder 321. Therefore, hardening of the mixed material in the mixing cylinder 321, the injection cylinder 410, or the nozzle 440 before the mixed material is injected into the cavity Cv can be suppressed. It should be noted that the temperature sensors 355 may be provided at the injection cylinder 410, instead of at the mixing cylinder 321. In this case, the control section 600 may determine whether or not the temperature of the mixed material is normal based on the temperatures detected by the temperature sensors 355 provided in the injection cylinder 410. The temperature sensors 355 may be provided in both the mixing cylinder 321 and the injection cylinder 410. In this case, the control section 600 may determine whether or not the temperature of the mixed material is normal based on the temperatures detected by at least one of the temperature sensors 355 provided at the mixing cylinder 321 and the temperature sensors 355 provided at the injection cylinder 410.

### C. Third Embodiment

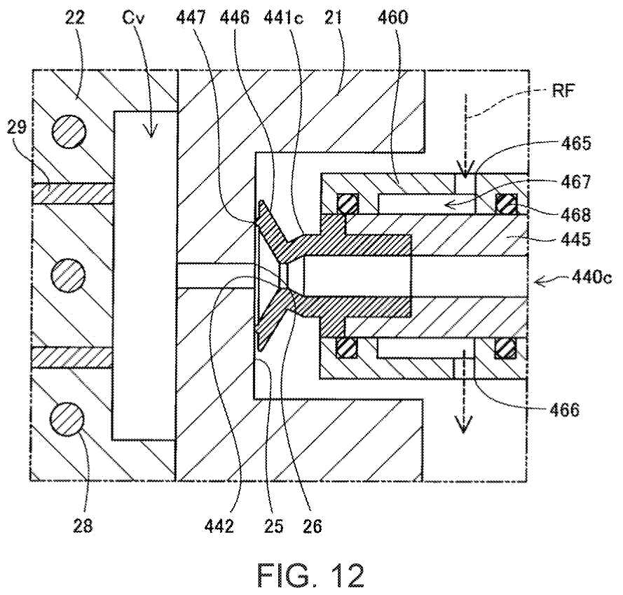

FIG. 12 is a cross sectional view showing configuration of a nozzle 440c of an injection molding apparatus 10c according to a third embodiment. In the injection molding apparatus 10c of the third embodiment, the shape of a tip end section of a nozzle tip 441c is different from that of the first embodiment. Other configurations are the same as those of the injection molding apparatus 10 of the first embodiment shown in FIG. 1, unless otherwise described.

In this embodiment, the nozzle tip 441c is formed of an elastomer having rubber elasticity. A skirt section 446 is provided at the tip end section of the nozzle tip 441c. The skirt section 446 has an outer shape of a truncated cone. Inner diameter and outer diameter of the skirt section 446 broaden toward the opening section forming surface 25. A convex section 447 is provided at an end surface of the skirt section 446. The convex section 447 protrudes toward the opening section forming surface 25. The convex section 447 is provided in an annular shape around a central axis of the nozzle tip 441c. When the fixed molding die 21 is mounted on the fixed plate 510, the skirt section 446 is pressed against the opening section forming surface 25 and elastically deforms along the opening section forming surface 25, and the entire circumference of the convex section 447 is in intimate contact with the opening section forming surface 25. In this embodiment, the sealing member 470 shown in FIG. 2 is not provided. The skirt section 446 may sometimes be referred to as an elastic deformation section. The nozzle tip 441c is preferably made of an elastomer having heat insulating properties. In this case, propagation of heat from the molding die 20 to the nozzle tip 441c can be suppressed.

According to the injection molding apparatus 10c of the present embodiment described above, since the convex section 447 is in intimate contact with the opening section forming surface 25, leakage of the mixed material from between the nozzle tip 441c and the opening section forming surface 25 can be suppressed. Further, since the convex section 447 of the skirt section 446 is in intimate contact with the opening section forming surface 25, it is possible to suppress portions other than the convex section 447 of the skirt section 446 from sticking to the opening section forming surface 25. The nozzle 440 of the injection molding apparatus 10b of the second embodiment may be configured by the nozzle 440c of the present embodiment.

### D. Fourth Embodiment

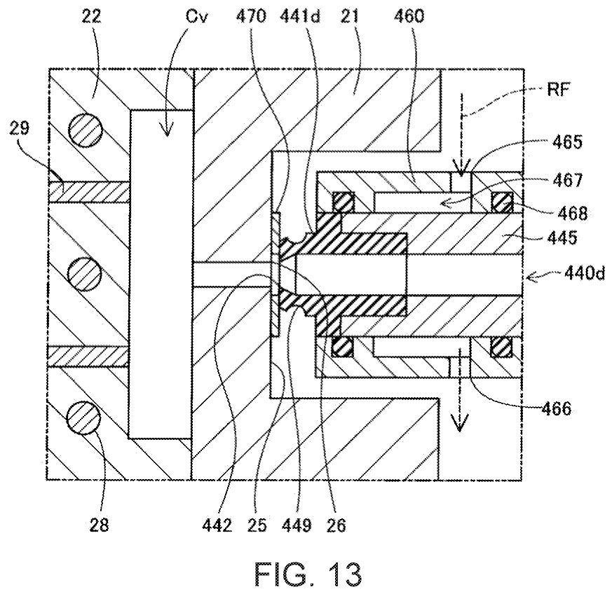

FIG. 13 is a cross sectional view showing configuration of a nozzle 440d of an injection molding apparatus 10d according to a fourth embodiment. In the injection molding apparatus 10d of the fourth embodiment, the shape of a tip end portion of a nozzle tip 441d is different from that of the first embodiment. Other configurations are the same as those of the injection molding apparatus 10 of the first embodiment shown in FIG. 1, unless otherwise described.

In this embodiment, the nozzle tip 441d is formed of an elastomer having rubber elasticity. A constriction section 449 is provided on an outer peripheral side surface of the tip end portion of the nozzle tip 441d. At the constriction section 449, the outer diameter of the nozzle tip 441d is reduced. When the fixed molding die 21 is mounted on the fixed plate 510, the constriction section 449 elastically deforms by the tip end portion of the nozzle tip 441d being pressed against the opening section forming surface 25, and the tip end surface of the nozzle tip 441d becomes parallel to the opening section forming surface 25, so that the entire circumference of the tip end surface of the nozzle tip 441d is in intimate contact with the opening section forming surface 25. In this embodiment, the sealing member 470 shown in FIG. 2 is not provided. The constriction section 449 may sometimes be referred to as an elastic deformation section.

According to the injection molding apparatus 10d of the present embodiment described above, since the tip surface of the nozzle tip 441d is in intimate contact with the opening section forming surface 25, leakage of the mixed material from between the nozzle tip 441d and the opening section forming surface 25 can be suppressed. Furthermore, since the constriction section 449 is provided at the tip end portion of the nozzle tip 441d, even if the tip end surface of the nozzle tip 441d contacts with the opening section forming surface 25 in a state where the tip end surface of the nozzle tip 441d is inclined with respect to the opening section forming surface 25, the tip end surface of the nozzle tip 441d can be in intimate contact with the opening section forming surface 25 in a state where it is parallel to the opening section forming surface 25. The nozzle 440 of the injection molding apparatus 10b of the second embodiment may be configured by the nozzle 440d of the present embodiment.

### E. Other Embodiments

E1. In the injection molding apparatus 10 of the first embodiment, the injection molding apparatus 10c of the third embodiment, and the injection molding apparatus 10d of the fourth embodiment described above, the control section 600 uses the first detection section 350 and the second detection section 450 to detect the mixing ratio of the first liquid and the second liquid in the mixed material and the mixed state of the mixed material. In contrast to this, the control section 600 of the injection molding apparatuses 10, 10c, and 10d may not detect one of the mixing ratio of the first liquid and the second liquid in the mixed material and the mixed state of the mixed material.

E2. In the injection molding apparatus 10b according to the second embodiment described above, the control section 600 uses the first detection section 350b and the second detection section 450 to detect the mixing ratio of the first liquid and the second liquid in the mixed material, the mixed state of the mixed material, and the temperature of the mixed material. In contrast, in the injection molding apparatus 10b, the control section 600 may not detect any one of the mixing ratio of the first liquid and the second liquid in the mixed material, the mixed state of the mixed material, and the temperature of the mixed material. Further, in the injection molding apparatus 10b, the control section 600 may not detect any two of the mixing ratio of the first liquid and the second liquid in the mixed material, the mixed state of the mixed material, and the temperature of the mixed material. For example, the control section 600 may detect the temperature of the mixed material using the temperature sensors 355 without detecting the mixing ratio of the first liquid and the second liquid in the mixed material and the mixed state of the mixed material. In this case, the pressure sensors 351 may not be provided at the mixing cylinder 321, and the pressure sensors 451 may not be provided at the injection cylinder 410.

E3. In the injection molding apparatus 10 of the first embodiment, the injection molding apparatus 10c of the third embodiment, and the injection molding apparatus 10d of the fourth embodiment described above, the control section 600 adjusts the output of at least one of the first pump 110 and the second pump 210 according to the mixing ratio of the first liquid and the second liquid in the mixed material detected by using the first detection section 350. In contrast to this, the control section 600 of the injection molding apparatuses 10, 10c, and 10d may not adjust the output of the first pump 110 according to the mixing ratio detected by using the first detection section 350 for the first liquid and the second liquid in the mixed material, and may not adjust the output of the second pump 210 according to the mixing ratio detected by using the first detection section 350 for the first liquid and the second liquid in the mixed material.

E4. In the injection molding apparatus 10b of the second embodiment described above, the control section 600 adjusts the output of at least one of the first pump 110 and the second pump 210 according to the mixing ratio detected by the first detection section 350b for the first liquid and the second liquid in the mixed material and to the temperature of the mixed material. In contrast to this, in the injection molding apparatus 10b, the control section 600 may not adjust the output of the first pump 110 according to the mixing ratio detected by using the first detection section 350b for the first liquid and the second liquid in the mixed material, and may not adjust the output of the second pump 210 according to the mixing ratio detected by using the first detection section 350b for the first liquid and the second liquid in the mixed material. In the injection molding apparatus 10b, the control section 600 may not adjust the output of the first pump 110 according to the temperature of the mixed material detected by using the first detection section 350b and may not adjust the output of the second pump 210 according to the temperature of the mixed material detected by using the first detection section 350b.

E5. In the injection molding apparatus 10 to 10d of each of the above described embodiments, the static mixer 320 in which the stirring member 325 does not rotate with respect to the mixing cylinder 321 is provided in the mixing section 300, and the static mixer 320 mixes the first liquid and the second liquid. In contrast to this, instead of the static mixer 320, a dynamic mixer in which the stirring member disposed in the mixing cylinder rotates with respect to the mixing cylinder may be provided in the mixing section 300, and the first liquid and the second liquid may be mixed by rotation of the stirring member. However, in a case where the dynamic mixer is provided in the mixing section 300, a mechanism for rotating the stirring member of the dynamic mixer is required, and thus it is desirable that the static mixer 320 having a simpler configuration is provided in the mixing section 300.

E6. In the injection molding apparatuses 10 to 10d of the embodiments described above, the mixing cylinder 321 is fixed to the flow path member 310 via the first coupling member 330. In contrast to this, without providing the first coupling member 330, for example, a male screw may be formed in the end portion of the mixing cylinder 321, a female screw may be formed in the flow path member 310, and the mixing cylinder 321 may be fixed to the flow path member 310 by the male screw and the female screw.

E7. In the injection molding apparatuses 10 to 10d of the embodiments described above, the mixing cylinder 321 is coupled to the injection cylinder 410 via the second coupling member 340. On the other hand, without providing the second coupling member 340, for example, a male screw may be formed in the end portion of the mixing cylinder 321, a female screw may be formed in the injection cylinder 410, and the mixing cylinder 321 may be fixed to the injection cylinder 410 by the male screw and the female screw.

E8. In the injection molding apparatuses 10 to 10d according to the above described embodiments, the nozzles 440, 440c, and 440d are provided with the refrigerant flow path 467 through which flows the refrigerant for cooling the nozzle tips 441, 441c, 441d, and the nozzle flow path member 445. On the other hand, instead of the refrigerant flow path 467, for example, a Peltier device for cooling the nozzle tips 441, 441c, 441d and the nozzle flow path member 445 may be provided in the nozzles 440, 440c, and 440d.

E9. In the injection molding apparatuses 10 to 10d of the above described embodiments, the refrigerant flow path 467 is provided in the nozzles 440, 440c, and 440d. In contrast to this, the refrigerant flow path 467 may not be provided in the nozzle 440.

### F. Other Configurations

The present disclosure is not limited to the embodiments described above, and can be realized in various configurations without departing from the spirit thereof. For example, the present disclosure can also be realized by the following configurations. The technical features in the above described embodiments corresponding to the technical features in each embodiment described below can be appropriately replaced or combined in order to solve a part or all of the problems of the present disclosure or to achieve a part or all of the effects of the present disclosure. In addition, unless the technical features are described as essential features in the present specification, the technical features can be appropriately deleted.

(1) According to an aspect of the present disclosure, an injection molding apparatus is provided. This injection molding apparatus includes a mixing section having a hollow cylinder and a stirring member disposed in the cylinder, the mixing section generating a mixed material by using the stirring member to mix a first liquid and a second liquid that flow through the cylinder, the first liquid containing a thermoset material and the second liquid containing a polymerization initiator for initiating a polymerization reaction of the thermoset material, an injection section having a nozzle and being configured to inject the mixed material from the nozzle toward a cavity defined by a fixed molding die and a movable molding die, a detection section configured to detect a state in the cylinder.

According to the injection molding apparatus of this aspect, the state in the cylinder into which flows the first liquid and the second liquid can be detected by the detection section. Therefore, it becomes possible to detect and cope with degradation in quality of the molded article beforehand.

(2) In the injection molding apparatus of the above aspect, the detection section may detects, as the state in the cylinder, at least one of a mixing ratio of the first liquid and the second liquid in the mixed material, a mixed state of the first liquid and the second liquid in the mixed material, and a temperature of the mixed material.

According to the injection molding apparatus of this aspect, since at least one of the mixing ratio of the first liquid and the second liquid in the mixed material, the mixed state of the first liquid and the second liquid in the mixed material, and the temperature of the mixed material, it is possible to detect and cope with deterioration in quality of the molded article beforehand.

(3) In the injection molding apparatus of the above aspect, the detection section may includes a plurality of sensors provided on the cylinder, and detects the state in the cylinder based on change in measurement values measured by the plurality of sensors.

According to the injection molding apparatus of this aspect, since the state in the cylinder is detected by the plurality of sensors, the state in the cylinder can be detected in more detail than in an aspect in which the state in the cylinder is detected by one sensor.

(4) The injection molding apparatus of the above aspect may further include a first pump configured to supply the first liquid to the cylinder, a second pump configured to supply the second liquid to the cylinder, a control section configured to control at least one of the first pump and the second pump in accordance with the state in the cylinder detected by the detection section.

According to the injection molding apparatus of this aspect, the control section controls the first liquid supply section and the second liquid supply section in accordance with the state in the cylinder detected by the detection section, so that the state in the cylinder can be appropriately maintained.

(5) In the injection molding apparatus of the above aspect, the mixing section may includes a static mixer having the cylinder and the stirring member that does not rotate with respect to the cylinder.

According to the injection molding apparatus of this aspect, the first liquid and the second liquid can be effectively mixed by the static mixer. Furthermore, energy consumption can be reduced as compared with an aspect in which the first liquid and the second liquid are mixed by rotating the stirring member disposed in the cylinder.

(6) The injection molding apparatus of the above aspect may further include a first flow path configured to introduce the first liquid into the cylinder, a second flow path configured to introduce the second liquid into the cylinder, and a flow path member having a merging flow path for bringing the first flow path and the second flow path into communication with the cylinder, wherein the mixing section includes a first coupling member for coupling the cylinder to the flow path member and the first coupling member includes a hollow first hollow section into which the cylinder is inserted, and a first flange section that is provided at an end portion of the first hollow section and that is fixed to the flow path member.

According to the injection molding apparatus of this aspect, the portion of the cylinder coupled to the flow path member can be reinforced by the first coupling member.

(7) In the injection molding apparatus of the above aspect, the mixing section may includes a second coupling member for coupling the cylinder to the injection section, the second coupling member includes a hollow second hollow section into which the cylinder is inserted, and a second flange section that is provided at an end portion of the second hollow section and that is fixed to the injection section, an inner wall surface of the second hollow section is provided with a convex section that is provided in an annular shape centered on a central axis of the second hollow section and that contacts the outer peripheral side surface of the cylinder.

According to the injection molding apparatus of this aspect, even if the mixed material leaks from the coupling section between the cylinder and the injection section, it is possible to suppress flow of mixed material out to the outside by the convex section provided on the inner wall surface of the second hollow section.

(8) In the injection molding apparatus of the above aspect, the fixed molding die may has an opening section forming surface in which an opening section, which communicates with the cavity, is formed and the nozzle has an elastic deformation section which elastically deforms along the opening section forming surface by contact with the opening section forming surface.

According to the injection molding apparatus of this aspect, since the elastic deformation section elastically deforms along the opening section forming surface, it is possible to suppress the occurrence of a space between the nozzle and the opening formation surface. Therefore, it is possible to suppress leakage of the mixed material from a space between the nozzle and the opening section forming surface.

(9) In the injection molding apparatus of the above aspect, the injection section may includes a cooling section that cools the nozzle.

According to the injection molding apparatus of this aspect, since the nozzle can be cooled by the cooling section, it is possible to suppress the mixed material from being hardened in the nozzle.

The present disclosure can also be realized in various configurations other than an injection molding apparatus. For example, the present disclosure can be realized in the configuration of a method for controlling an injection molding apparatus.

What is claimed is:

1. An injection molding apparatus, comprising:
a mixing section having a hollow cylinder and a stirring member disposed in the cylinder, the mixing section generating a mixed material by using the stirring member to mix a first liquid and a second liquid that flow through the cylinder, the first liquid containing a thermoset material and the second liquid containing a polymerization initiator for initiating a polymerization reaction of the thermoset material;
an injection section having a nozzle and being configured to inject the mixed material from the nozzle toward a cavity defined by a fixed molding die and a movable molding die; and
a detection section configured to detect a state in the cylinder.

2. The injection molding apparatus according to claim 1, wherein
the detection section detects, as the state in the cylinder, at least one of a mixing ratio of the first liquid and the second liquid in the mixed material, a mixed state of the first liquid and the second liquid in the mixed material, and a temperature of the mixed material.

3. The injection molding apparatus according to claim 1, wherein
the detection section includes a plurality of sensors provided on the cylinder, and detects the state in the cylinder based on change in measurement values measured by the plurality of sensors.

4. The injection molding apparatus according to claim 1, further comprising:
a first pump configured to supply the first liquid to the cylinder;
a second pump configured to supply the second liquid to the cylinder; and
a control section configured to control at least one of the first pump and the second pump in accordance with the state in the cylinder detected by the detection section.

5. The injection molding apparatus according to claim 1, wherein
the mixing section includes a static mixer having the cylinder and the stirring member that does not rotate with respect to the cylinder.

6. The injection molding apparatus according to claim 1, further comprising:
a first flow path configured to introduce the first liquid into the cylinder;
a second flow path configured to introduce the second liquid into the cylinder; and
a flow path member having a merging flow path for bringing the first flow path and the second flow path into communication with the cylinder, wherein
the mixing section includes a first coupling member for coupling the cylinder to the flow path member and
the first coupling member includes a hollow first hollow section into which the cylinder is inserted, and a first flange section that is provided at an end portion of the first hollow section and that is fixed to the flow path member.

7. The injection molding apparatus according to claim 1, wherein
the mixing section includes a second coupling member for coupling the cylinder to the injection section,
the second coupling member includes a hollow second hollow section into which the cylinder is inserted, and a second flange section that is provided at an end portion of the second hollow section and that is fixed to the injection section, and
an inner wall surface of the second hollow section is provided with a convex section that is provided in an annular shape centered on a central axis of the second hollow section and that contacts the outer peripheral side surface of the cylinder.

8. The injection molding apparatus according to claim 1, wherein
the fixed molding die has an opening section forming surface in which an opening section, which communicates with the cavity, is formed and
the nozzle has an elastic deformation section which elastically deforms along the opening section forming surface by contact with the opening section forming surface.

9. The injection molding apparatus according to claim 1, wherein
the injection section includes a cooling section that cools the nozzle.
